(19) United States
(12) Patent Application Publication
(10) Pub. No.: US 2014/0145971 A1
(43) Pub. Date: May 29, 2014

(54) TOUCH Panel

(71) Applicant: Chih-Chung Lin, Taipei City (TW)

(72) Inventor: Chih-Chung Lin, Taipei City (TW)

(21) Appl. No.: 13/726,197

(22) Filed: Dec. 23, 2012

(30) Foreign Application Priority Data
Nov. 27, 2012 (TW) 101144245

(51) Int. Cl. G06F 3/041

(52) U.S. Cl. CPC G06F 3/041
USPC 345/173

(57) ABSTRACT

A touch panel includes a substrate and a transparent conductor pattern. The substrate includes a display area and a first and a second peripheral area located outside and adjacent to two opposite sides of the display area. The transparent conductor pattern is formed on the substrate within the display area and includes a plurality of first electrodes and a plurality of second electrodes corresponding to the first electrodes. The second electrodes respectively have an electrode lead wire. The electrode lead wires of some of the second electrodes are extended into the first peripheral area to connect to a first peripheral wire structure in the first peripheral area while the electrode lead wires of the other second electrodes are extended into the second peripheral area to a second peripheral wire structure in the second peripheral area.

This application claims the priority benefit of Taiwan patent application number 101144245 filed on Nov. 27, 2012.

### FIELD OF THE INVENTION

The present invention relates to a touch panel, and more particularly to a touch panel that has electrode lead wires extended in two opposite directions and thereby has narrowed inactive areas occupied by the electrode lead wires.

### BACKGROUND OF THE INVENTION

Touch panels have been applied to various kinds of electronic products, such as smartphones, mobile phones, tablet computers and notebook computers, which are popular in today's consumptive electronic product market. A touch panel provides a user with a completely new and humanized operating interface, via which the user can conveniently and intuitively manipulate objects displayed on a screen of the electronic product or give instructions to the electronic product directly with one or more fingers or a stylus.

Currently, there are three types of touch panels that are very common in the market, namely, resistive touch panel, capacitive touch panel and surface acoustic wave touch panel. In any type, the touch panel usually includes a display area and a peripheral area surrounding the display area. The display area enables the generation of touch sensing signals. In the peripheral area, there is provided a plurality of peripheral wires for transmitting the touch sensing signals to a signal processor for computing, so as to get the coordinates of the touched position or positions on the touch panel.

According to the general design of the touch panel, there are transparent sensing electrodes provided within the display area. The transparent sensing electrodes include X-sensing electrodes and Y-sensing electrodes. Please refer to FIG. 1 that shows a conductor pattern 104 for a conventional touch panel 100. As shown, the conventional touch panel 100 has a display area 101 surrounded by a peripheral area 103. The peripheral area 103 includes an upper area 103a, a lower area 103b, a right area 103c and a left area 103d.

A plurality of peripheral wires 106 is formed in the upper area 103a of the peripheral area 103 of the touch panel 100.

The conductor pattern 104 is formed in the display area 101 of the touch panel 100, and includes a plurality of first sensing electrodes 1041, a plurality of second sensing electrodes 1042, and a plurality of interval spaces 1043. The first sensing electrodes 1041 are spaced from one another, and the interval spaces 1043 are formed between any two adjacent first sensing electrodes 1041. Further, in each of the interval spaces 1043, there are arrayed multiple second sensing electrodes 1042. In other words, every first sensing electrode 1041 corresponds to the multiple second sensing electrodes 1042 in one interval space 1043. The second sensing electrodes 1042 in each of the interval spaces 1043 respectively have an electrode lead wire 10421, and all the electrode lead wires 10421 in the same interval space 1043 are extended from the display area 101 into the upper area 103a to connect to the peripheral wires 106 in the upper area 103a. And, all the first sensing electrodes 1041 are also connected at their upper ends to the peripheral wires 106 in the upper area 103a. Through the connection of the electrode lead wires 10421 to the peripheral wires 106, the sensing signals generated by the sensing electrodes can be transmitted to a processor (not shown).

In the above-described conventional touch panel 100, since the electrode lead wires 10421 of all the second electrodes 1042 in each of interval spaces 1043 are extended in the same direction into the upper area 103a, a relatively large area in each interval space 1043 is occupied by these electrode lead wires 10421 to form a large inactive area A. With this type of design, the inactive areas A in the interval spaces 1043 are quite wide because the electrode lead wires 10421 of all the second electrodes 1042 extended in the same direction into the upper area 103a occupy too many areas in the interval spaces 1043. As a result, the conductor pattern 104 has a large array distance that tends to cause low sensitivity to touch and low linearity of the touch panel 100. In addition, since there are too many peripheral wires 106 to be connected to a flexible circuit board, the defective rate in connecting the wires to the flexible circuit board is high.

It is therefore desirable to improve the existing conductor pattern for the touch panel, in order to reduce the width of the inactive areas and to maximize the display area.

### SUMMARY OF THE INVENTION

A primary object of the present invention is to provide a novel touch panel structure, of which a transparent conductor pattern formed on a display area of a substrate includes a plurality of second electrodes that are distributed in multiple interval spaced defined between a plurality of spaced first electrodes and respectively have an electrode lead wire, and the electrode lead wires are extended in two or more different directions into different peripheral areas outside the display area, so that widths of inactive areas formed in the interval spaces due to occupation by the electrode lead wires can be reduced. In this manner, the touch panel can have upgraded sensitivity to touch and increased linearity.

Another object of the present invention is to provide a touch panel having at least one parallel-connection zone that is provided in a peripheral area of the touch panel and includes a peripheral wire structure, so that electrode lead wires of a plurality of second electrodes of the touch panel arrayed into horizontal rows are parallel-connected to one another via the peripheral wire structure. Since the number of wires in the peripheral wire structures is smaller than that of the electrode lead wires, the number of contacts between the wires and a flexible circuit board is largely reduced. Therefore, through the parallel-connection of the peripheral wire structure to the electrode lead wires of the second electrodes, it is able to reduce the number of contacts with the flexible circuit board and accordingly, the defective rate of connection of the wires to the flexible circuit board.

To achieve the above and other objects, the touch panel according to a first embodiment of the present invention includes a substrate having a display area and a peripheral area surrounding the display area; at least one parallel-connection zone defined in the peripheral area and including a plurality of insulating sections and a peripheral wire structure extended through over the insulating sections; and a plurality of first and second electrodes provided within the display area, and the second electrodes respectively having an electrode lead wire extended from the display area into the parallel-connection zone to electrically parallel-connect to the peripheral wire structure.

In the first embodiment of the present invention, the peripheral wire structure includes a plurality of first wires and a plurality of second wires; and the first wires are parallel-connected to some of the electrode lead wires while the second wires are parallel-connected to the other electrode lead wires.

In the first embodiment of the present invention, the first and the second electrodes as well as the electrode lead wires together form a transparent conductor pattern.

In the first embodiment of the present invention, the peripheral area includes a first, a second, a third and a fourth peripheral area. The first and the second peripheral area are located adjacent to a first and an opposite second side of the display area, and the third and the fourth peripheral area are located adjacent to a third and an opposite fourth side of the display area.

According to a second embodiment of the present invention, the touch panel includes a substrate, a transparent conductor pattern, and a first parallel-connection zone. The substrate has a display area, a first peripheral area and a second peripheral area, and the first and the second peripheral area are located outside and adjacent to a first side and an opposite second side of the display area. The transparent conductor pattern is formed within the display area and includes a plurality of first electrodes spaced from one another to define an interval space between any two adjacent first electrodes, and a plurality of second electrodes distributed in each of the interval spaces to correspond to the first electrodes. Some of the second electrodes respectively have a first electrode lead wire while the other second electrodes respectively have a second electrode lead wire. The first electrode lead wires are extended into the first peripheral area, and the second electrode lead wires are extended into the second peripheral area. The first parallel-connection zone is defined in the first peripheral area and includes a plurality of first insulating sections and a first peripheral wire structure. The first insulating sections are provided above the first electrode lead wires and the first peripheral wire structure is extended through over the first insulating sections and connected to the first electrode lead wires.

In the second embodiment, the first peripheral wire structure includes a plurality of first wires and a plurality of second wires; and the first wires are connected to some of the first electrode lead wires while the second wires are connected to the other first electrode lead wires. Further, the first wires are extended from the first peripheral area through the third peripheral area to the second peripheral area, and the second wires are extended from the first peripheral area through the fourth peripheral area to the second peripheral area.

The touch panel according to the second embodiment of the present invention can further include a second parallel-connection zone defined in the second peripheral area. The second parallel-connection zone includes a plurality of second insulating sections and a second peripheral wire structure. The second insulating sections are provided above the second electrode lead wires, and the second peripheral wire structure are extended through over the second insulating sections and connected to the second electrode lead wires. The second peripheral wire structure includes a plurality of third wires, a plurality of fourth wires and a plurality of fifth wires. The third wires are connected to some of the second electrode lead wires while the fourth wires are connected to the other second electrode lead wires, and the fifth wires are connected to the first electrodes.

In the present invention, the first and the second peripheral wire structure are formed of a metal material selected from the group consisting of silver paste, copper and molybdenum (Mo).

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows a conventional touch panel and a conductor pattern thereof;

FIG. 2 is a rear view of a substrate with a patterned mask layer for a touch panel according to a first preferred embodiment of the present invention;

FIG. 3 shows a transparent conductor pattern formed within a display area of the substrate for the touch panel according to the first preferred embodiment of the present invention;

FIG. 4 shows a first parallel-connection zone is defined and a plurality of insulating sections is formed on the substrate of the touch panel according to the first preferred embodiment of the present invention;

FIG. 5 shows a first peripheral wire structure formed on the substrate of the touch panel according to the first preferred embodiment of the present invention;

FIGS. 6A to 6D show how a plurality of second electrodes in the conductor pattern arrayed in multiple horizontal rows is parallel-connected to the first peripheral wire structure of FIG. 5;

FIG. 7 shows an equivalent structure of the first parallel-connection zone shown in FIG. 5;

FIG. 8 is a sectional view taken along line Y-Y′ of FIG. 5;

FIG. 9 is a sectional view taken along line X-X′ of FIG. 5; and

FIG. 10 shows a touch panel according to a second preferred embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

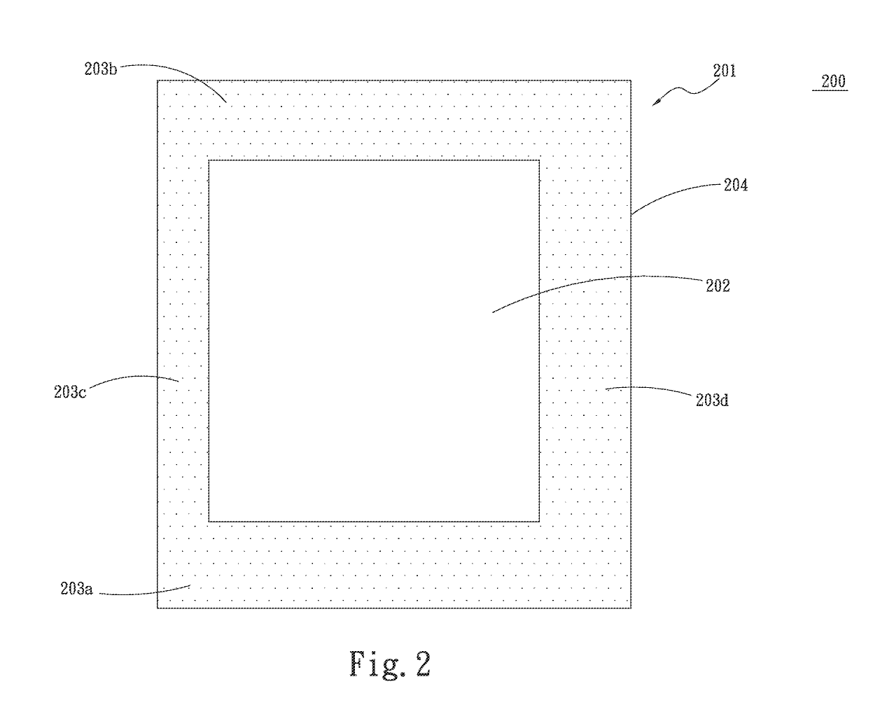

Please refer to FIGS. 2 to 5, which sequentially show the forming of a touch panel 200 according to a first preferred embodiment of the present invention. Firstly, as shown in FIG. 2, a substrate 201 is provided to serve as a base, on which a conductor pattern for the touch panel 200 is formed. The substrate 201 is a transparent or light-pervious plate, which can be made of transparent silica glass, polymethylmethacrylate (PMMA), polycarbonate (PC) or polyethylene terephthalate (PET), for protecting conducting lines in the touch panel 200. The substrate 201 has an outer or front side serving as a touch surface for a user to touch with one or more fingers or a stylus. The substrate 201 also allows light of images emitted by a display module, such as a liquid crystal display module, inside the touch panel 200 to pass therethrough, so that images can be presented before the user. Here, the touch panel 200 of the present invention is described by viewing the substrate 201 from a rear side thereof. The rear side of the substrate 201 is also an inner side of the substrate 201 that could not be touched by the user when using the touch panel 200.

As can be seen in FIG. 2, the substrate 201 includes a display area 202 and a peripheral area surrounding the display area 202. The peripheral area includes a first peripheral area 203a and a second peripheral area 203b located adjacent to a first and an opposite second side of the display area 202, respectively, as well as a third peripheral area 203c and a fourth peripheral area 203d located adjacent to a third and an opposite fourth side of the display area 202, respectively. A patterned mask layer 204 is provided on the substrate 201 corresponding to the first to the fourth peripheral area 203a-203d. That is, the patterned mask layer 204 is located around the display area 202 to mask and conceal the peripheral area. In the first preferred embodiment of the present invention, the patterned mask layer 204 can be formed by printing or coating, for example, an opaque or non-light-pervious insulating material on the substrate 201 in the first to the fourth peripheral area 203a-203d.

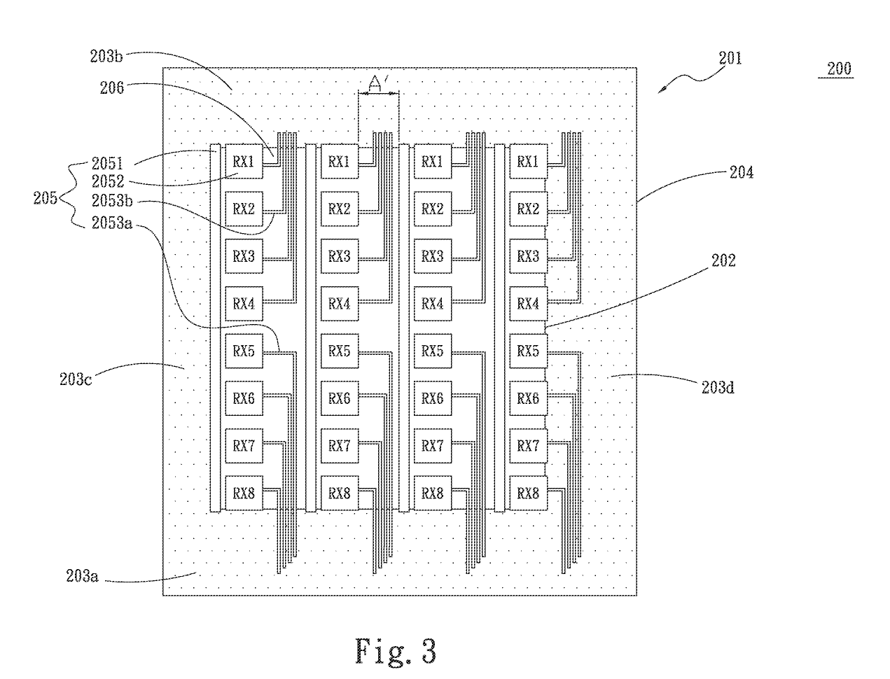

Please refer to FIG. 3. After forming the patterned mask layer 204 in the first to the fourth peripheral area 203a-203d to divide the substrate 201 into the display area 202 and the peripheral area, a transparent conductor pattern 205 is then formed on the touch panel 200 within the display area 202 by way of photolithography or other suitable way to constitute a touch zone of the touch panel 200. The transparent conductor pattern 205 can be a capacitive sensing electrode including a plurality of vertically extended first electrodes 2051 and a plurality of second electrodes 2052 arrayed into a plurality of horizontal rows. In the illustrated first preferred embodiment, the second electrodes 2052 in each horizontal row are similarly marked. For example, the second electrodes 2052 in the first row all are marked by RX1. The first electrodes 2051 are vertically spaced from one another in the display area 202, so that an interval space 206 is defined between any two adjacent first electrodes 2051. The second electrodes 2052 are correspondingly distributed in each of the interval spaces 206 to correspond to one first electrode 2051. In each of the interval spaces 206, some of the second electrodes 2052 respectively have a first electrode lead wire 2053a while the others respectively have a second electrode lead wire 2053b. The first electrode lead wires 2053a are extended in a first direction, which is a downward direction in the illustrated drawings, into the first peripheral area 203a, and the second electrode lead wires 2053b are extended in an opposite second direction, which is an upward direction in the illustrated drawings, in the second peripheral area 203b. In other words, the electrode lead wires for some of the second electrodes 2052, i.e. the first electrode lead wires 2053a, and the electrode lead wires for the other second electrodes 2052, i.e. the second electrode lead wires 2053b, are extended in two opposite directions.

The first electrodes 2051 and the second electrodes 2052 are distributed on the substrate 201 as an array for sensing the user's different touch gestures on the outer surface of the substrate 201, such as sliding, clicking and the like, and converting each of the touch gestures into a sensing signal. A full width occupied by the traces of the first and the second electrode lead wires 2053a, 2053b in each of the interval spaces 206 forms an inactive area A′.

To avoid hindering the display of images on the display area 202, the first electrodes 2051, the second electrodes 2052, the first electrode lead wires 2053a and the second electrode lead wires 2053b of the transparent conductor pattern 205 are formed of a transparent conductive material, such as indium tin oxide (ITO), indium zinc oxide (IZO), cadmium tin oxide (CTO), aluminum zinc oxide (AZO), indium tin zinc oxide (ITZO), zinc oxide, cadmium oxide, hafnium oxide (HfO), indium gallium zinc oxide (InGaZnO), indium gallium zinc magnesium oxide (InGaZnMgO), indium gallium magnesium oxide (InGaMgO), or indium gallium aluminum oxide (InGaAlO).

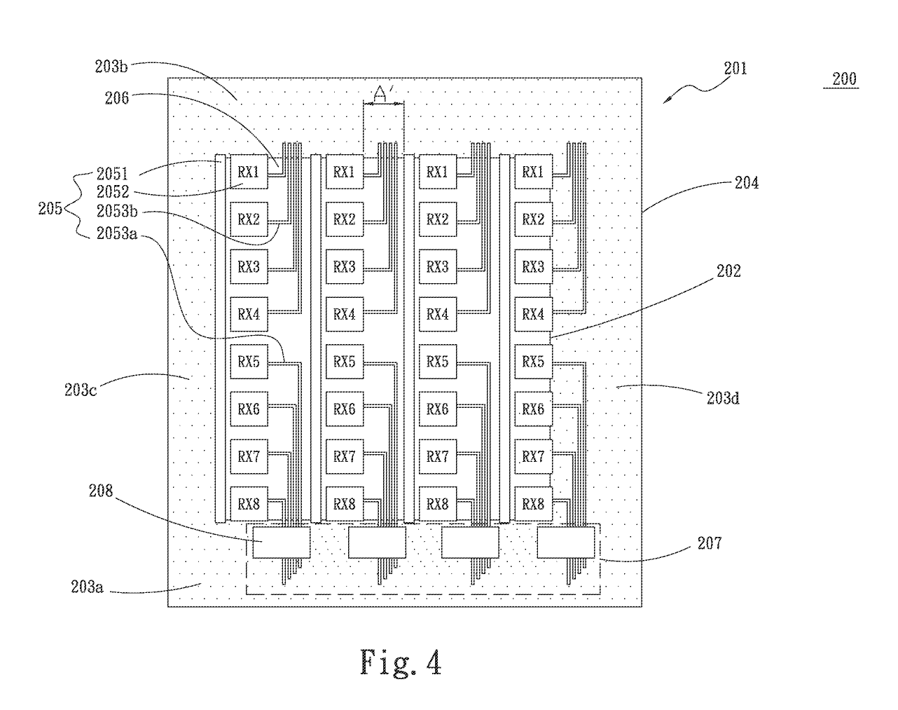

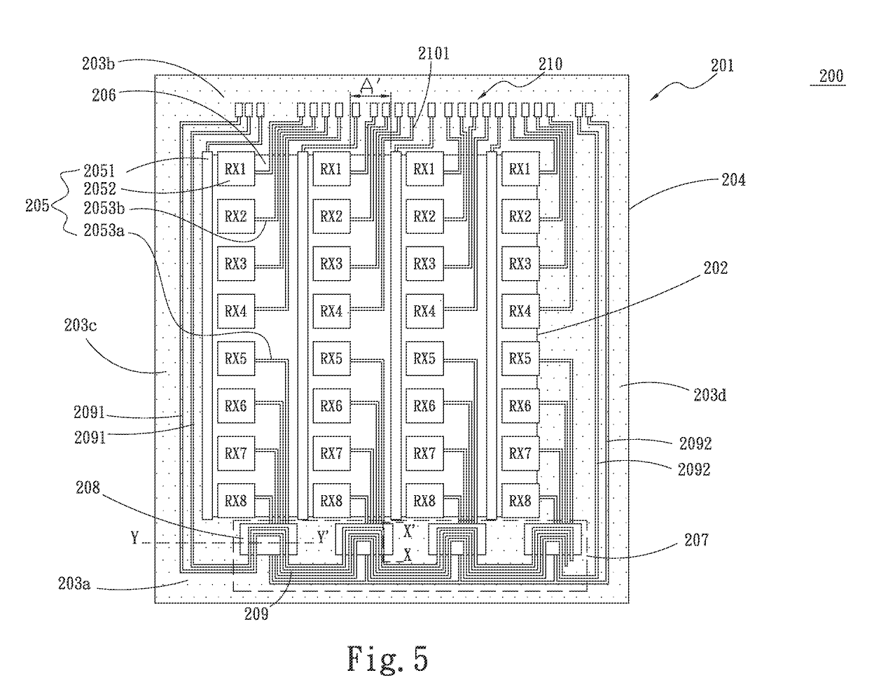

Please refer to FIG. 4. After forming the transparent conductor pattern 205, at least one parallel-connection zone is then defined in the first peripheral area 203a or the second peripheral area 203b. In the illustrated first preferred embodiment, a first parallel-connection zone 207 is defined in the first peripheral area 203a. In the parallel-connection zone 207, there is a plurality of first insulating sections 208, which partially cover portions of the first electrode lead wires 2053a that are extended beyond the interval spaces 206 into the first peripheral area 203a. The function of terminal ends of the first electrode lead wires 2053a in the first peripheral area 203a that are not covered by the first insulating sections 208 will be described in details with reference to FIG. 5 later. The first insulating sections 208 can be formed of a multi-layer polyester film or an inorganic material.

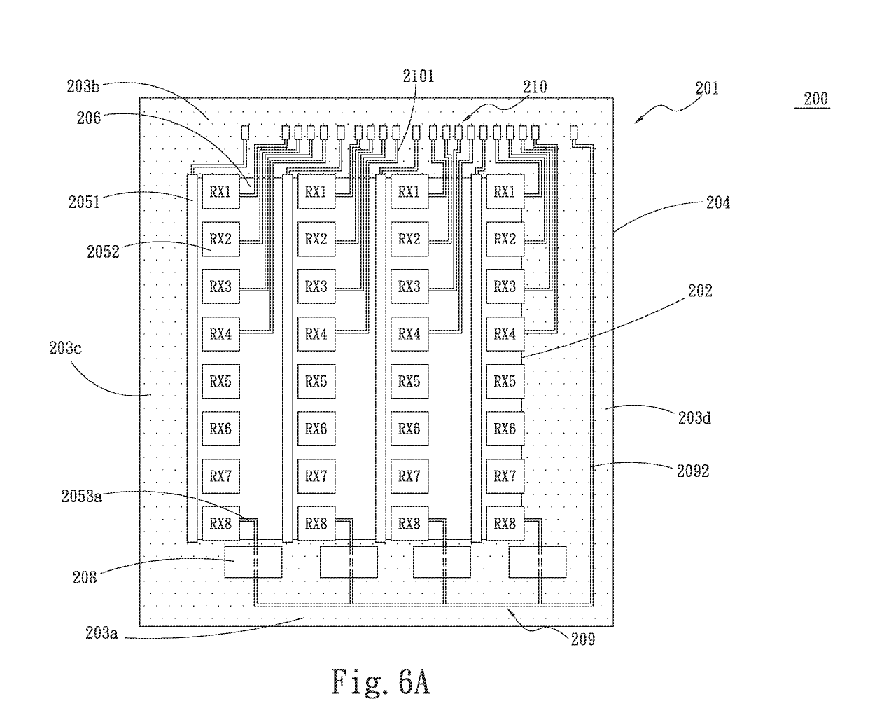

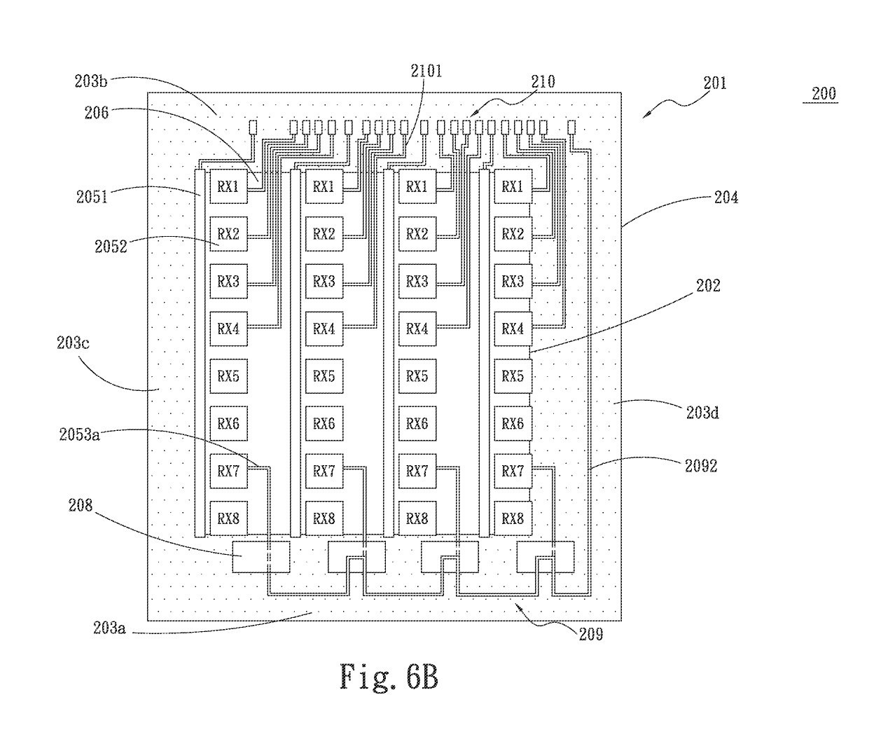

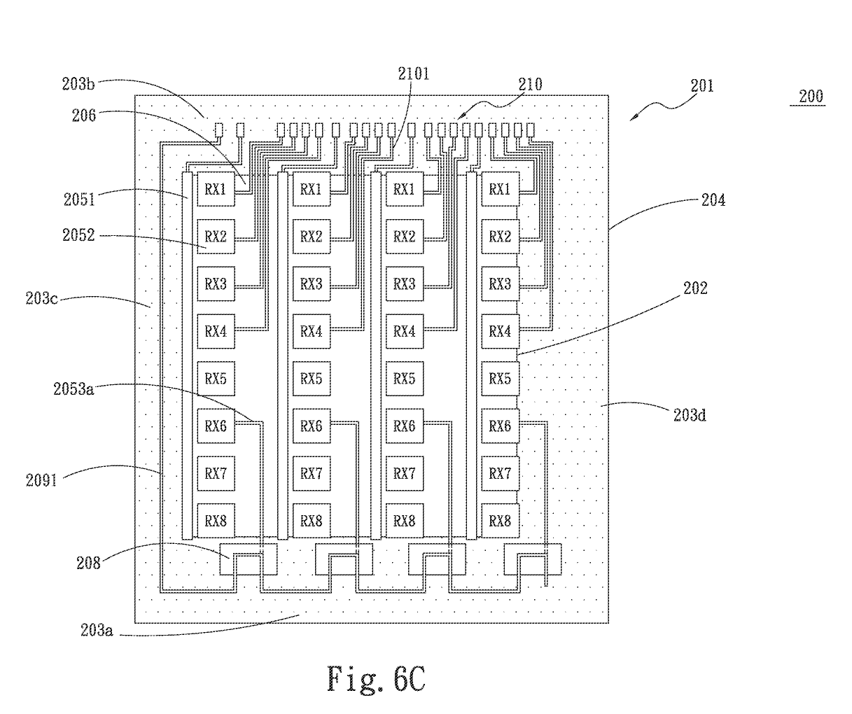

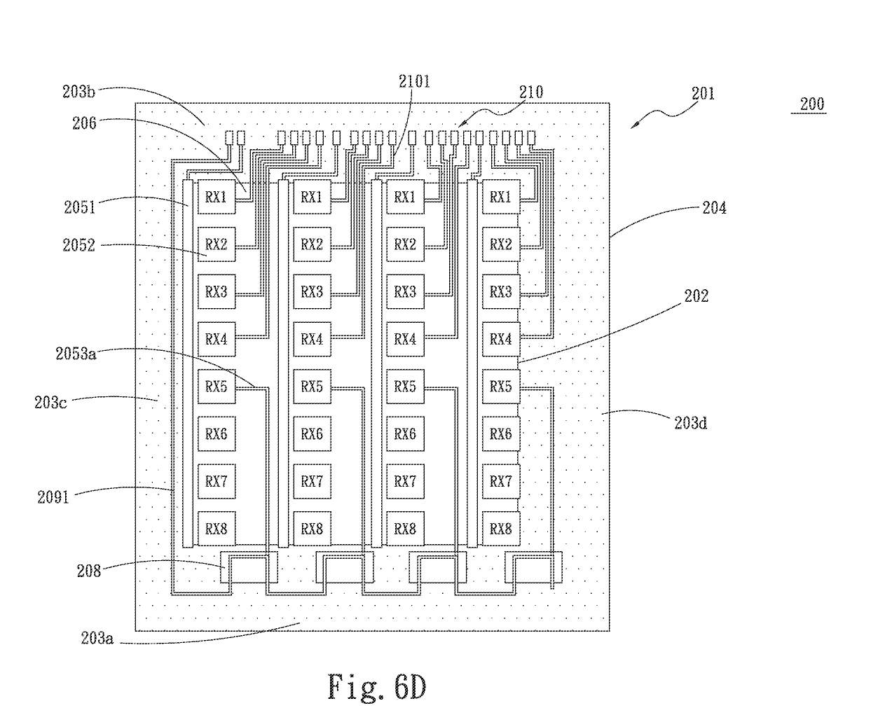

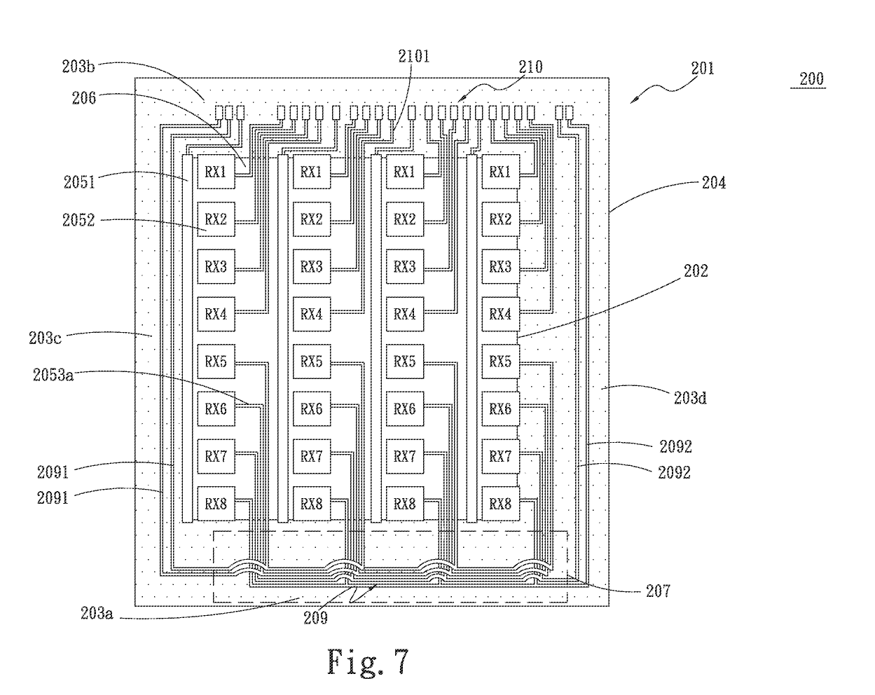

Please refer to FIG. 5. After defining the first parallel-connection zone 207 and partially covering the first electrode lead wires 2053a with the first insulating sections 208, a first peripheral wire structure 209 and a second peripheral wire structure 210 are then formed in the first peripheral zone 203a and the second peripheral zone 203b, respectively. The first peripheral wire structure 209 is located in the first parallel-connection zone 207 on the patterned mask layer 204 to sequentially extend through over the first insulating sections 208. The terminal ends of the first electrode lead wires 2053a that are not covered by the first insulting sections 208 are connected to the first peripheral wire structure 209 when the latter extends through the first parallel-connection zone 207. The first peripheral wire structure 209 includes a plurality of first wires 2091 and a plurality of second wires 2092. The first wires 2091 are correspondingly connected to some of the first electrode lead wires 2053a while the second wires 2092 are connected to the other first electrode lead wires 2053a. That is, the first electrode lead wires 2053a of the second electrodes 2052 in the same horizontal row are parallel-connected to one another via the first wires 2091 or the second wires 2092. Such parallel-connection will be described in more details with reference to FIGS. 6A to 6D and FIG. 7 later. Through the parallel-connection of the first electrode lead wires 2053a to one another via the first and the second wires 2091, 2092, it is able to reduce the number of junctions of the first electrode lead wires 2053a.

The first wires 2091 are extended from the first peripheral area 203a through the third peripheral area 203c to the second peripheral area 203b; and the second wires 2092 are extended from the first peripheral area 203a through the fourth peripheral area 203d to the second peripheral area 203b. The second peripheral wire structure 210 includes a plurality of third wires 2101 correspondingly connected to the second electrode lead wires 2053b and the first electrodes 2051. The first peripheral wire structure 209 and the second peripheral wire structure 210 can be electrically connected to an integrated circuit (IC) mainboard or an LCD flexible circuit board by way of flex bonding.

The first peripheral wire structure 209 and the second peripheral wire structure 210 can be formed of silver paste or other metal materials, such as copper or molybdenum (Mo). When the silver paste is employed, it can be printed onto the patterned mask layer 204 in the first to the fourth peripheral area 203a-203d through a printing process to form the first and second peripheral wire structures 209, 210. On the other hand, when a metal material is employed, the first and second peripheral wire structures 209, 210 can be formed through printing process or photolithography.

The parallel-connection of the first electrode lead wires 2053a to one another via the first peripheral wire structure 209 is now described in more details with reference to FIGS. 6A to 6D. To enable clearer illustration of the connection of the electrode lead wires to the first wires 2091 and the second wires 2092, the wires and the electrode lead wires that are not described with reference to any of the FIGS. 6A to 6D are temporarily omitted from that figure.

As can be seen in FIG. 6A, the first electrode lead wires 2053a of the second electrodes 2052 located in the interval spaces 206 in the eighth horizontal row, i.e. the second electrodes 2052 being marked by RX8, are respectively extended through below the first insulating sections 208 and parallel-connected to one another via one of the second wires 2092 of the first peripheral wire structure 209. The second wire 2092 is then extended from the first peripheral area 203a through the fourth peripheral area 203d to the second peripheral area 203b.

Then, as can be seen in FIG. 6B, the first electrode lead wires 2053a of the second electrodes 2052 located in the interval spaces 206 in the seventh horizontal row, i.e. the second electrodes 2052 being marked by RX7, are respectively extended through below the first insulating sections 208 and parallel-connected to one another via another one of the second wires 2092 of the first peripheral wire structure 209. The second wire 2092 is then extended from the first peripheral area 203a through the fourth peripheral area 203d to the second peripheral area 203b.

Then, as can be seen in FIG. 6C, the first electrode lead wires 2053a of the second electrodes 2052 located in the interval spaces 206 in the sixth horizontal row, i.e. the second electrodes 2052 being marked by RX6, are respectively extended through below the first insulating sections 208 and parallel-connected to one another via one of the first wires 2091 of the first peripheral wire structure 209. The first wire 2091 is then extended from the first peripheral area 203a through the third peripheral area 203c to the second peripheral area 203b.

Then, as can be seen in FIG. 6D, the first electrode lead wires 2053a of the second electrodes 2052 located in the interval spaces 206 in the fifth horizontal row, i.e. the second electrodes 2052 being marked by RX5, are respectively extended through below the first insulating sections 208 and parallel-connected to one another via another one of the first wires 2091 of the first peripheral wire structure 209. The first wire 2091 is then extended from the first peripheral area 203a through the third peripheral area 203c to the second peripheral area 203b.

FIG. 7 shows an equivalent structure of the first parallel-connection zone 207 shown in FIG. 5. To enable clearer illustration of the parallel-connection of each of the first wires 2091 and the second wires 2092 to the first electrode lead wires 2053a as well as the extending of the first wires 2091 and the second wires 2092 through over the first electrode lead wires 2053a, the first insulating sections 208 shown in FIG. 5 are not shown in FIG. 7. In FIG. 7, the first electrode lead wires 2053a of the second electrodes 2052 in the same horizontal row are parallel-connected to one another via the first wires 2091 or the second wires 2092, and portions of the first wires 2091 and the second wires 2092 respectively showing a semicircle in FIG. 7 indicate the first and the second wires 2091, 2092 jump over the first insulating sections 208 and accordingly isolate from some of the first electrode lead wires 2053a, which are extended through below the first insulating sections 208.

The touch panel 200 of the present invention can further include a protective layer (not shown) covered on the transparent conductor pattern 205, the first insulating sections 208, the first peripheral wire structure 209 and the second peripheral wire structure 210, so as to protect various elements in the display area 202 and the first to the fourth peripheral area 230a-203d as well as the transparent conductor pattern 205 against chemical corrosion or physical damages. The protective layer can be formed of an inorganic material, such as silicon nitride, silicon oxide or silicon oxynitride; or an organic material, such as acrylic resin; or other suitable materials.

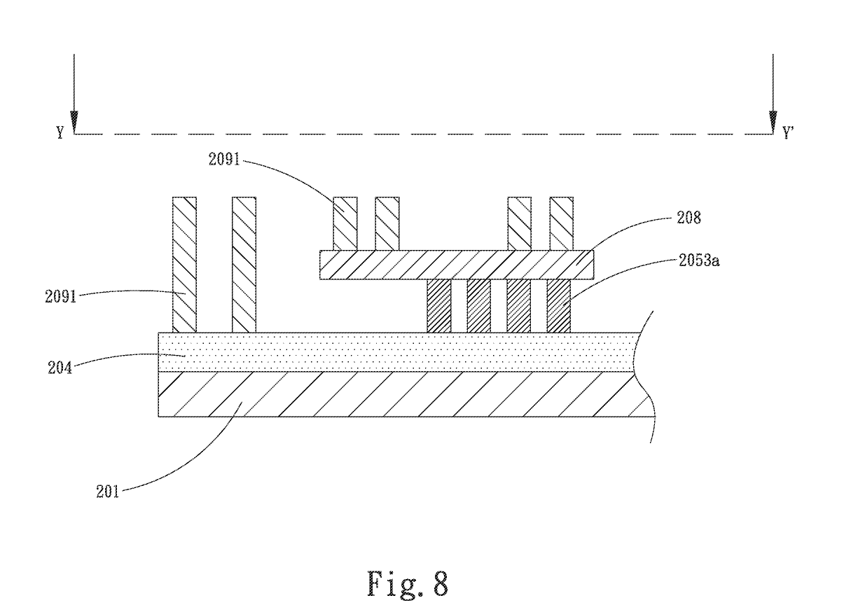

FIG. 8 is a sectional view taken along line Y-Y′ of FIG. 5 to show a layered structure thereat. For the purpose of simplicity, elements in other areas and zones of the touch panel 200 are omitted from FIG. 8 and are not described in words herein. As can be clearly seen in FIG. 8, the substrate 201 serves as a base, on which the conductor pattern 205 for the touch panel 200 is formed in the display area 202. The patterned mask layer 204 is formed on the substrate 201 in the peripheral area 203, and the first electrode lead wires 2053a of the second electrodes 2052 (also refer to FIG. 5) are extended onto the patterned mask layer 204 in the first peripheral area 203a. The first insulating sections 208 partially cover the first electrode lead wires 2053a, and the first wires 2091 of the first peripheral wire structure 209 (see FIG. 5) are extended through over the first insulating sections 208.

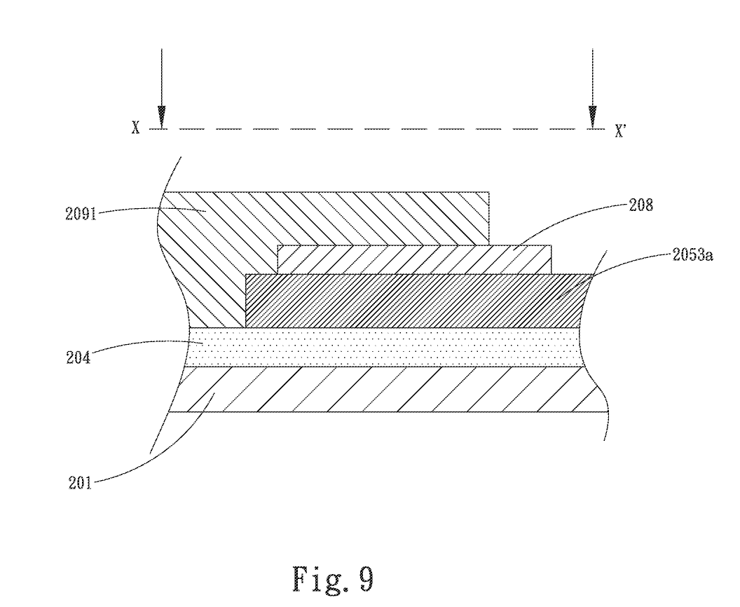

FIG. 9 is a sectional view taken along line X-X′ of FIG. 5 to show a layered structure thereat. For the purpose of simplicity, elements in other areas and zones of the touch panel 200 are omitted from FIG. 9 and are not described in words herein. As can be clearly seen in FIG. 9, the first wires 2091 of the first peripheral wire structure 209 (also refer to FIG. 5) are extended from the patterned mask layer 204 through over the first insulating sections 208, and portions of the first electrode lead wires 2053a that are not covered by the first insulating sections 208 are connected to the first wires 2091.

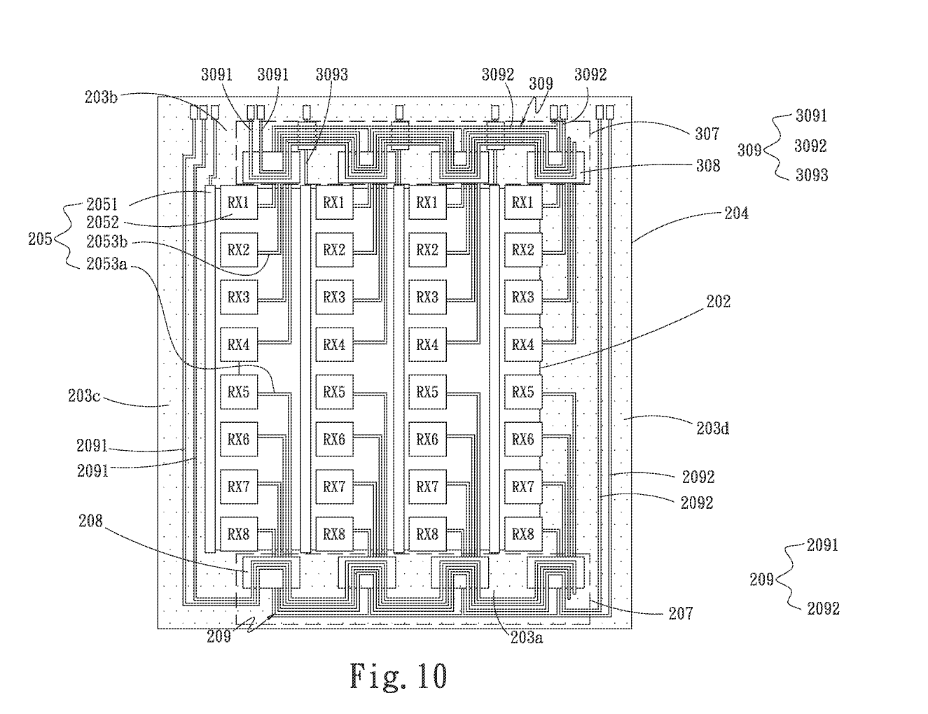

FIG. 10 shows a touch panel according to a second preferred embodiment of the present invention. As shown, the second preferred embodiment is generally structurally similar to the first preferred embodiment, and the same elements in the two preferred embodiments are denoted by the same reference numerals. The second preferred embodiment is different from the first preferred embodiment in further including a second parallel-connection zone 307 defined in the second peripheral area 203a. In the second parallel-connection zone 307, there are formed a plurality of second insulating sections 308 and a second peripheral wire structure 309. The second insulating sections 308 partially cover the second electrode lead wires 2053b, and can be formed of a multi-layer polyester film or an inorganic material. The second peripheral wire structure 309 is located in the second parallel-connection zone 307 on the patterned mask layer 204 to sequentially extend through over the second insulating sections 308. The second peripheral wire structure 309 is formed of a material and through a process the same as those for the first peripheral wire structure 209. Further, the second peripheral wire structure 309 includes a plurality of third wires 3091, a plurality of fourth wires 3092 and a plurality of fifth wires 3093. The third wires 3091 are connected to some of the second electrode lead wires 2053b, the fourth wires 3092 are connected to the other second electrode lead wires 2053b, and the fifth wires 3093 are connected to the first electrodes 2051.

More specifically, the second electrodes 2052 located in the interval spaces 206 in the first, the second, the third and the fourth horizontal row are marked by RX1, RX2, RX3 and RX4, respectively. The second electrode lead wires 2053b of the second electrodes 2052 in each of the first to the fourth horizontal rows are parallel-connected to one another via the third wires 3091 or the fourth wires 3092. Through parallel-connection of the second electrode lead wires 2053b to one another via the first and the second wires 3091, 3092, it is able to reduce the number of junctions of the second electrode lead wires 2053b.

Moreover, the second insulating sections 308 and the first insulating sections 208 can be formed at the same time in one step; and the second peripheral wire structure 309 and the first peripheral wire structure 209 can be formed at the same time in one step.

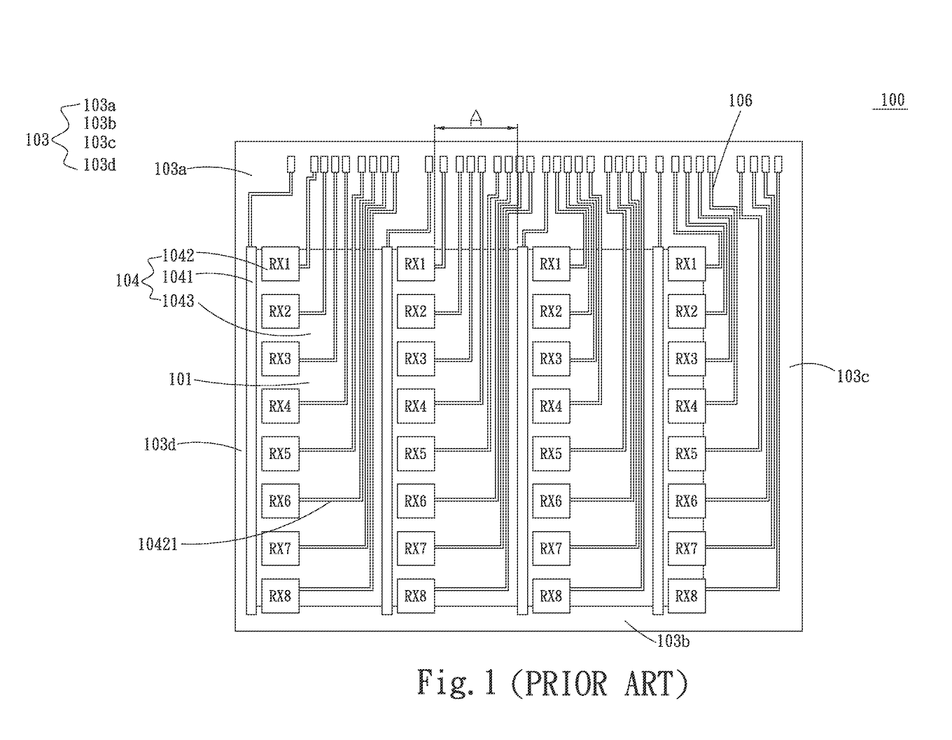

In brief, in the touch panel designed and manufactured according to the present invention, the first electrode lead wires 2053a and the second electrode lead wires 2053b of the second electrodes 2052 in the interval spaces 206 are extended downward to the first peripheral area 203a and upward to the second peripheral area 203b, respectively, to thereby reduce the width of inactive areas A′ occupied by the traces of the first and the second electrode lead wires 2053a, 2053b. Compared to the inactive areas A in the conventional touch panel 100 shown in FIG. 1, the inactive areas A′ in the touch panel 200 of the present invention apparently respectively have a largely reduced width. Accordingly, the first electrodes 2051 and the second electrodes 2052 of the transparent conductor pattern 205 can be more densely arrayed on the substrate 201 to enable upgraded sensitivity to touch and upgraded linearity of the touch panel. Moreover, since the number of the wires of the peripheral wire structures is smaller than that of the electrode lead wires, the terminal ends of the wires are fewer than that of the electrode lead wires. Therefore, through the parallel-connection of the first peripheral wire structure 209 and/or the second peripheral wire structure 309 to the first electrode lead wires 2053a and/or the second electrode lead wires 2053b of the second electrodes 2052 in the interval spaces 206 in each of the horizontal rows, it is able to reduce the number of terminal ends to be connected to a flexible circuit board. As a result, the flexible circuit board can have a reduced size and the defective rate of the connection of the wires to the flexible circuit board can be lowered. Finally, the touch panel of the present invention uses silver paste to form the first and the second peripheral wire structure 209, 309, and therefore has reduced signal transmission impedance compared to the conventional touch panel. That is, in the touch panel of the present invention, when the sensing signal is transmitted from the first electrode lead wires 2053a and/or the second electrode lead wires 2053b to the first and/or the second peripheral wire structure, respectively, the signal can be transmitted at an increased speed, which in turn increases the sensitivity of the touch panel.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A touch panel, comprising:
a substrate including a display area and a peripheral area surrounding the display area;
a patterned mask layer being provided on the peripheral area;
at least one parallel-connection zone being defined in the peripheral area on the patterned mask layer, and having a plurality of insulating sections and a peripheral wire structure formed therein; and the peripheral wire structure being extended through over the insulating sections; and
a plurality of first electrodes and a plurality of second electrodes provided in the display area; each of the second electrodes having an electrode lead wire, and the electrode lead wires being extended from the display area into the parallel-connection zone on the patterned mask layer to be partially covered by the insulating sections; such that terminal ends of the electrode lead wires that are not covered by the insulating sections are connected to the peripheral wire structure.

2. The touch panel as claimed in claim 1, wherein the peripheral wire structure includes a plurality of first wires and a plurality of second wires; and the first wires being connected to some of the electrode lead wires while the second wires being connected to the other electrode lead wires.

3. The touch panel as claimed in claim 2, wherein the electrode lead wires connected to the first wires and the electrode lead wires connected to the second wires are extended in two opposite directions.

4. The touch panel as claimed in claim 1, wherein areas occupied by the electrode lead wires in the display area form inactive areas.

5. The touch panel as claimed in claim 1, wherein the first electrodes, the second electrodes and the electrode lead wires together form a transparent conductor pattern.

6. The touch panel as claimed in claim 1, wherein the peripheral area includes a first, a second, a third and a fourth peripheral area; the first and the second peripheral area being located adjacent to a first and an opposite second side of the display area, and the third and the fourth peripheral area being located adjacent to a third and an opposite fourth side of the display area.

7. The touch panel as claimed in claim 1, wherein the peripheral wire structure is formed of a metal material selected from the group consisting of silver paste, copper and molybdenum (Mo).

8. A touch panel, comprising:
a substrate including a display area and at least a first and a second peripheral area located outside and adjacent to two opposite sides of the display area;
a patterned mask layer being provided on each of the first and the second peripheral area;
a transparent conductor pattern being formed within the display area and including:
a plurality of first electrodes; and
a plurality of second electrodes corresponding to the first electrodes and respectively having an electrode lead wires; some of the electrode lead wires being extended onto the patterned mask layer in the first peripheral area, and the other electrode lead wires being extended onto the patterned mask area in the second peripheral area; and
at least one parallel-connection zone being defined in any one or each of the first and the second peripheral area; each parallel-connection zone including a plurality of insulating sections and a peripheral wire structure; the insulating sections being provided above the electrode lead wires, and the peripheral wire structure being provided on the patterned mask layer to connect to the electrode lead wires and extend through over the insulating sections.

9. A touch panel, comprising:
a substrate including a display area, a first peripheral area and a second peripheral area; and the first and the second peripheral area being located outside and adjacent to a first side and an opposite second side of the display area;
a patterned mask layer being provided on each of the first and the second peripheral area;
a transparent conductor pattern being formed within the display area and including:
a plurality of first electrodes being spaced from one another, so that an interval space is defined between any two adjacent first electrodes; and
a plurality of second electrodes being correspondingly distributed in each of the interval spaces to correspond to one first electrode; some of the second electrodes respectively having a first electrode lead wires while the other second electrodes respectively having a second electrode lead wires; the first electrode lead wires being extended onto the patterned mask layer in the first peripheral area, and the second electrode lead wires being extended onto the patterned mask area in the second peripheral area; and
a first parallel-connection zone being defined in the first peripheral area; the first parallel-connection zone including a plurality of first insulating sections and a first peripheral wire structure; the first insulating sections being provided above the first electrode lead wires, and the first peripheral wire structure being provided on the patterned mask layer to connect to the first electrode lead wires and extend through over the first insulating sections.

10. The touch panel as claimed in claim 9, wherein the first peripheral wire structure includes a plurality of first wires and a plurality of second wires; and the first wires being connected to some of the first electrode lead wires while the second wires being connected to the other first electrode lead wires.

11. The touch panel as claimed in claim 9, wherein the substrate further includes a third peripheral area and a fourth peripheral area located outside and adjacent to a third side and an opposite fourth side of the display area.

12. The touch panel as claimed in claim 11, wherein the patterned mask layer is also provided on each of the third and the fourth peripheral area.

13. The touch panel as claimed in claim 11, wherein the first wires are extended from the first peripheral area through the third peripheral area to the second peripheral area, and the second wires are extended from the first peripheral area through the fourth peripheral area to the second peripheral area.

14. The touch panel as claimed in claim 10, further comprising a second parallel-connection zone defined in the second peripheral area; the second parallel-connection zone including a plurality of second insulating sections and a second peripheral wire structure; the second insulating sections being provided above the second electrode lead wires, and the second peripheral wire structure being provided on the patterned mask layer to connect to the second electrode lead wires and extend through over the second insulating sections.

15. The touch panel as claimed in claim 14, wherein the second peripheral wire structure includes a plurality of third wires, a plurality of fourth wires and a plurality of fifth wires; the third wires being connected to some of the second electrode lead wires while the fourth wires being connected to the other second electrode lead wires, and the fifth wires being connected to the first electrodes.

16. The touch panel as claimed in claim 15, wherein the first and the second peripheral wire structure are formed of a metal material selected from the group consisting of silver paste, copper and molybdenum (Mo).

17. The touch panel as claimed in claim 9, wherein the first electrode lead wires and the second electrode lead wires are extended in two opposite directions.

18. The touch panel as claimed in claim 9, wherein an area occupied by the first electrode lead wires and the second electrode lead wires in each of the interval spaces forms an inactive area.
